(19) United States
(12) Patent Application Publication
(10) Pub. No.: US 2020/0050730 A1
(43) Pub. Date: Feb. 13, 2020

(54) RE-ROUTING TIME CRITICAL MULTI-SINK NETS IN CHIP DESIGN

(71) Applicant: INTERNATIONAL BUSINESS MACHINES CORPORATION, Armonk, NY (US)

(72) Inventor: LUKAS DAELLENBACH, ALTDORF (DE)

(21) Appl. No.: 16/056,585

(22) Filed: Aug. 7, 2018

(51) Int. Cl. G06F 17/50

(52) U.S. Cl. CPC G06F 17/5077; G06F 17/505

(57) ABSTRACT

A method for improving a routing of a single chip multi-sink net of a semiconductor circuit may be provided. The method includes receiving a netlist describing at least one routed multi-sink net and timing information related to a signal propagation delay between a source and individual sinks. The method also includes determining a timing slack value related to a routed path from the source to the individual sinks and determining at least one critical sink out of the individual sinks based on the related timing slack value, wherein the critical sink has a related timing slack value that is larger than a predefined threshold value. The method additionally includes deleting all routed wires of the multi-sink net, and rerouting the multi-sink net, wherein at least one subnet of the multi-sink net, comprising the source and the critical sink, is routed before routing the remaining individual sinks of the multi-sink net.

### BACKGROUND

The invention relates generally to a routing of a single chip multi-sink net, and more specifically, to a computer-implemented method for improving a routing of a single chip multi-sink net of a semiconductor circuit. The invention relates further to a related routing system for improving a routing of a single chip multi-sink net of a semiconductor circuit, and a computer program product.

Routing of wires and signal paths continues to be more an art than a science for large multi-sink nets of complex integrated circuits. Normally, routing of a chip (circuit design) is a three step mechanism. It typically starts with a global routing (g/route) which creates wire trunks with a width and metal layer given through tags, followed by a conduit route (c/route) which defines the correct space between the above wire trunks. The last step of the three-step routing mechanism is the so-called detailed route (d/route) step, which connects the wire trunks to the source pins and sink pins and creates also the DRC (Design Rule Check) correct routing.

Though, g/routes and c/routes are the basis of the signal buffering. This is needed to potentially repower signals by buffers so that the signal slews at the sinks are correct and not too slow. G/routes are used to find the optimal buffer position because the real wiring will then, after d/route, be near the buffer position. This may avoid detours and long and scenic routes.

Routers, which use a time-driven tagging may be much more effective with better routing and timing quality than length-based tagging routers. The given routing resources are used more effectively and the buffering, which were placed under the g/routes make more sense. But in some multi-sink nets, one may find effective g/routes when the critical sink is far away from then uncritical sinks. Additionally, g/routes can be found for the critical segments, which do not have a minimum Manhattan distance so that the wires are longer than needed and after buffering one may find often more buffers in the route than even needed. In some cases, the designer may then delete manually the complete g/route of the multi-sink nets and then buffers it without any route information. This has been a sub-optimal approach in the past.

### SUMMARY

According to one aspect of the present invention, a computer-implemented method for improving a routing of a single chip multi-sink net of a semiconductor circuit may be provided. The method may include receiving a netlist—in particular design data. The netlist may describe at least one routed multi-sink net and timing information related to a signal propagation delay value between a source of the multi-sink net and individual sinks of the multi-sink net. The method may further include determining at least one timing slack value related to a routed path from the source to one of the individual sinks based on the timing information, determining at least one critical sink out of the individual sinks based on the related timing slack value, wherein the critical sink has a related timing slack value that is larger than a predefined threshold value, deleting all routed wires of the multi-sink net, wherein the routed wires relate to data describing physical shapes of connections between the source and the individual sinks, and rerouting the multi-sink net, wherein at least one subnet of the multi-sink net, including the source and the critical sink, is routed before routing the remaining individual sinks of the multi-sink net.

According to another aspect of the present invention, a related routing system for improving a routing of a single chip multi-sink net of a semiconductor circuit may be provided. The system may include a processor and a memory coupled to the processor for executing program instructions and a receiver unit adapted to receiving a netlist. The netlist may describe at least one routed multi-sink net and timing information related to a signal propagation delay value between a source of the multi-sink net and individual sinks of the multi-sink net. The system may further include a slack determination unit adapted for determining at least one timing slack value related to a routed path from the source to one of the individual sinks based on the timing information, a critical sink determination unit adapted for determining at least one critical sink out of the individual sinks based on the related timing slack value, wherein the critical sink has a related timing slack value that is larger than a predefined threshold value, and a deletion unit adapted for deleting all routed wires of the multi-sink net, wherein the routed wires relate to data describing physical shapes of connections between the source and the individual sinks. Last but not least, the system may include a rerouting unit adapted for rerouting the multi-sink net, wherein at least one subnet of the multi-sink net, including the source and the critical sink, is routed before routing the remaining individual sinks of the multi-sink net.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

### BRIEF DESCRIPTION WS OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above, and further aspects of the present invention, are apparent from the examples of embodiments to be described hereinafter and are explained with reference to the examples of embodiments, but to which the invention is not limited. Embodiments of the invention will be described, by way of example only, and with reference to the following drawings:

FIG. 1 shows a block diagram of an embodiment of the inventive computer-implemented method for improving a routing of a single chip multi-sink net of a semiconductor circuit.

FIG. 2 shows a block diagram of a more implementation-near embodiment of the proposed method.

FIG. 3 shows a shortened block diagram of an advanced embodiment of the proposed method.

FIG. 4 shows another shortened block diagram of an advanced embodiment of the proposed method.

FIG. 5 shows a block diagram of an embodiment of the proposed system for improving a routing of a single chip multi-sink net of a semiconductor circuit.

FIG. 6 shows an embodiment of a computing system comprising the proposed system for improving a routing of a single chip multi-sink net of a semiconductor circuit.

### DETAILED DESCRIPTION

In the context of this description, the following conventions, terms and/or expressions may be used:

The term ‘routing’ may denote—in electronic design—a wire routing, commonly called simply routing, as a step in the design of integrated circuits (ICs) or single chip semiconductor circuits comprising a plurality of multi-sink nets. It may be built on a preceding step, called placement, which determines the location of each active element of an IC. After placement, the routing step may add wires needed to properly connect the placed components while obeying all design rules for the IC. Different metal layers with different timing characteristics may be used for the wires. Typically, the routing process connects signals sources with one or more signal sinks. Each of these connections may be denoted as net. Also, normally thinner wires are placed on/in lower layers, i.e., lower level connection or wire planes.

A primary task of the router may be to create geometries such that all terminals assigned to the same net are connected, no terminals assigned to different nets are connected, and all design rules are obeyed. Distances are typically measured in the so-called Manhattan distance solving a so called Steiner tree problem.

Design rules sometimes may vary considerably from wire layer to layer. For example, the allowed width and spacing on the lower layers may be four or more times smaller than the allowed widths and spacings on the upper layers.

The term ‘single chip multi-sink net’ may denote multiple connections on a single chip semiconductor device from one source—in particular one source pin—to one or more related signal sinks—in particular the individual sink pins.

The term ‘semiconductor circuit’ may denote an integrated circuit (IC) implemented on a semiconductor die.

The term ‘netlist’ may denote—in particular, in electronic design—a description of the component or device connectivity of an electronic circuit. In its simplest form, a netlist may comprise a list of the electronic components or devices in a circuit and a list of the nodes—in particular source pins and sink pins—they are connected to. A network (net) is a collection of two or more interconnected components. Devices belong to different nets, i.e., multi-sink nets, may not have a connection to each other.

The structure, complexity and representation of netlists may vary considerably, but the fundamental purpose of every netlist is to convey connectivity information. Netlists usually provide nothing more than instances, nodes, and perhaps some attributes of the components involved, e.g., location on the chip. If they express much more than this, they are usually considered to be a hardware description language such VHDL, or one of several languages specifically designed for input to simulators. —Netlists may be physical or, instance-based or net-based, and flat or hierarchical. The latter can be either folded or unfolded.

The term ‘timing information’ may typically denote the required travel time of a signal from a source pin to a sink pin in a net using the existing, real wires, which may typically be organized as rectangularly connected flat wires in different layers with different widths and thus, different signal delays. If a connection from one wire layer to another may be required, vias from one wire layer to another wire layer may be used.

The term ‘signal propagation delay’ may denote the time required from a source pin to a sink pin by a traveling signal.

The term ‘source’ may denote the origin of a signal dedicated to reach a sink.

The term ‘individual sinks’ may here denote sinks relating to a specific (individual) source, and thus, to one multi-sink net.

The term ‘timing slack’ may denote and may be defined as the timing difference of a signal from a source to a sink between the required arrival time (RAT) and the actual arriving time (AT) due to signal propagation delays on a wire from a source pin to a sink pin: t_{slack}=t_{RAT}−t_{AT}. Consequently, the value of t_{slack} is positive if a signal has enough time to travel from a source to a sink. In case of a negative t_{slack} value, the arrival time of a signal would be too late, so that the circuit would not function as required. Using today's technology, a critical slack value t_{slack} may lie below zero <0 (e.g., in the range −0.1 to, e.g., −25 ps, or even more negative).

The term ‘routed path’ or a ‘route’ may denote a physical wire based on segments of different metal layers and vias. In this context, the term ‘wires’ may typically denote physical metal stripes generated using, e.g., a silicon electronic CAD (computer aided design) design tool.

The term ‘critical sink’ may denote a signal sink having a negative t_{slack} value.

The term ‘subnet’ may denote a portion of a multi-sink net comprising a wire from the source to one of the individual multiple sinks of the multi-sink net. Basically, it may denote, e.g., an electrically connected component of an electronic circuit, namely the source and one of a set of potentially critical sinks.

The term ‘remaining individual sinks’ may denote all those sinks of a multi-sink net that do not have a critical or negative t_{slack} value.

The term ‘slack group’ may denote multi-sink nets having at least one critical sink with a t_{slack}.

The term ‘slack group’ may denote multi-sink nets having at least one critical sink with a t_{slack} value in a predefined range. Examples of slack group names may comprise “critical”, “semi-critical”, “non-critical. As an example, a critical group may have t_{slack}<−10 ps, a semi-critical group may have slack values of −10 ps<t_{slack}<+10 ps, and a non-critical group may relate to slack values above +10 ps (t_{slack}>10 ps). However, other group parameters may be selected. It may, e.g., also be useful to assign connections with t_{slack}<0 to the group of critical slack values, i.e., critical sinks or critical connections from the source to the sink in the net.

The proposed computer-implemented method for improving a routing of a single chip multi-sink net of a semiconductor circuit may offer multiple advantages and technical effects:

Basically, in a post process (after the initial routing approach), when there are time sensitive segments in an existing routing—i.e., an existing netlist—the g/route process may create the minimum, or at least a shorter distance between the source and the critical sink using the same metal layer or use a lower metal layer for the critical segments. The uncritical segments of a given multi-sink net may use longer routes or may be moved to a lower metal layer with slower signal speed.

The objective of the proposed method to reduce the number of critical sinks in one or more multi-sink nets of the netlist can be achieved. Generally speaking, the proposed method and related algorithm may analyze multi-sink nets in order to determine whether there are critical and uncritical segments, i.e., analyze multi-sink nets in a fully routed and timed design to identify multi-sink nets, which do not reach the timing targets (e.g., t_{slack}<t_{threshold}). Different calculation methods may be used in order to determine critical net elements (e.g., based on the metal layer wire lengths, the wire width and an RC-delay model, etc.). For a calculation of the net length the known Manhattan-distance wire length between a source and one or more of the sinks may easily be used. It is also worth mentioning that the proposed method may also be applicable to a fully timed and tagged design without already routed wires.

The deletion of all information of already routed connections—as defined by the received netlist—in the multi-sink net determined comprising a critical sink may generate space on one or more metal layers to find a better—i.e., shorter—path for the critical connection between the source and the related sink in question so that less signal delay are involved. Once the critical path (i.e., critical connection or critical sub-net) is rerouted, also other non-critical sub-nets may be rerouted in the multi-sink net. The other individual sinks of the sub-net may be ignored during the rerouting of the once critical sink.

Additionally, the proposed core method may leave room for further improvements like determining an order of the critical multi-sink nets—e.g., sorted by decreasing slack values—and/or grouping a plurality of multi-sink nets into groups of predefined criticality, i.e., each group with a predefined range of slack values. Also within such a group, a rerouting priority may be given to those sinks within a multi-sink net and/or between multi-sink nets.

Additionally, at predefined times—e.g., after a rerouting of one or more of the multi-sink nets—new timing parameters of all interacting components of the netlist may be determined. This way, new multi-sink nets with one or more critical sinks may be determined. This new knowledge may be used for a new optimization iteration of the routing. It may be noted that the proposed method relates mainly to the g/route portion of a three-step routing process (as defined above). In any case, the designer always works system-supported and may no longer be required to work in a trial error manner.

In the following, additional embodiments—also applicable for the related method—will be presented:

According to one advantageous embodiment, the method may also comprise determining multiple critical multi-sink nets, wherein each of the critical multi-sink nets comprises at least one critical sink, and then selecting iteratively one of the determined multiple critical multi-sink nets for a routing iteration, wherein the routing iteration comprises a rerouting of the iteratively selected one of the determined multiple critical multi-sink nets. Hence, a plurality of critical multi-sink nets may be determined—according to at least one parameter characteristic for the criticality of the critical multi-sink net—and once the multi-sink nets are known they may be rerouted. No specific order for the rerouting may be used in such an embodiment. However, in another embodiment, the most critical multi-sink net may be determined—i.e., the one with the worst slack value (i.e., the most negative value) for one of the sinks in the multi-sink net—which may then be rerouted first. Consequently, an order may be built in which the multi-sink nets may be rerouted: from the worst slack value of a critical sink in the related multi-sink net to the one with the least worse slack value.

Hence, according to another advantageous embodiment, the method may also comprise determining an order of the critical sinks of each of the determined multiple critical multi-sink nets, wherein a rank in the order is defined by a decreasing slack value of the respective critical sinks. Hence, those sinks may be rerouted first having the worst slack value (most negative ones). Thus, also inside each net an order of the sinks—i.e., the subnets—may be determined, so that within, and in-between, the multi-sink nets a rerouting may be performed in a sequence from the worst slack value (most negative) to the least bad slack value.

Alternatively, in one embodiment, the method may comprise rerouting the multiple multi-sink nets simultaneously, wherein subnets of the multiple multi-sink nets are routed one after another according to the determined decreasing order of their respective critical sinks.

According to one optional embodiment of the method, the determining the order of the critical sinks may also comprise assigning the critical sinks to one slack group of a predefined set of slack groups. As an example, the groups “critical”, “semi-critical”, “least-critical” may be used. The rerouting may be performed per group starting with the group “critical,” continuing with the group “semi-critical” and finishing with the group “least-critical”. Again, within each group, a sorting of the criticality (according to the slack value of a signal arrival time of a sink) may be determined. The sorting may again be used for a sequence of a rerouting, starting with the sink having the respective worst slack value. The group may have non-overlapping slack values.

Consequently, in one embodiment, the method may comprise rerouting the multiple multi-sink net slack group by slack group starting with the slack group comprising the sinks having the worst slack values. Also within each group, a sorting may be determined and the rerouting may be performed according to descending negative slack values (starting with the most negative one to those being positioned to zero). For the sorting, a database may be used.

The grouping may be applied within one multi-sink net and/or also across different multi-sink nets. Furthermore, the proposed method may be applied to critical groups (i.e., groups comprising critical sinks) as well as to groups comprising semi-critical group because for these additional buffers may be required which may add additional delays.

According to one possible embodiment, the method may comprise, after the rerouting of one or more of the multi-sink nets comprising critical sinks, rerouting the semiconductor circuit with all remaining multi-sink nets of all devices of the complete single chip. Thus, all routed connection of the netlist may be deleted and rerouted. It may turn out that other source/sink connections may have become critical so that respective actions have to be taken.

According to one advanced embodiment, the method may also comprise, determining all or parts of the non-critical multi-sink nets from the netlist, in particular before a rerouting of critical source/sink connections. A non-critical multi-sink net may be characterized by a positive slack value larger than a predefined threshold value (e.g., zero). Then, the method may also comprise deleting all—or selected—connections relating to the non-critical multi-sink nets and optionally also all—or selected—non-critical point-to-point nets from the netlist. This way, space may be created on this semiconductor die for the critical multi-sink nets. The non-critical multi-sink nets may be rerouted after the critical multi-sink nets have been rerouted.

According to one further advanced embodiment, the method may also comprise rerouting the multi-sink nets comprising a critical sink after the deleting of all connections relating to the non-critical multi-sink, and rerouting the remaining portions of the netlist excluding the multi-sink nets comprising a critical sink; they have been rerouted already. Thus, in the end, critical multi-sink nets, as well as, formerly non-critical multi-sink nets have been rerouted such that a complete netlist becomes available again.

According to a further preferred embodiment, the method may also comprise determining timing parameters of the completely rerouted netlist. This may unearth new bottle necks, i.e., new multi-sink nets with new critical sinks. Then the process may be redone until an acceptable timing may be reached as part of the g/route process.

In the following, a detailed description of the figures will be given. All instructions in the figures are schematic. Firstly, a block diagram of an embodiment of the inventive computer-implemented method for improving a routing of a single chip multi-sink net of a semiconductor circuit is given. Afterwards, further embodiments, as well as embodiments of the routing system for improving a routing of a single chip multi-sink net of a semiconductor circuit, will be described.

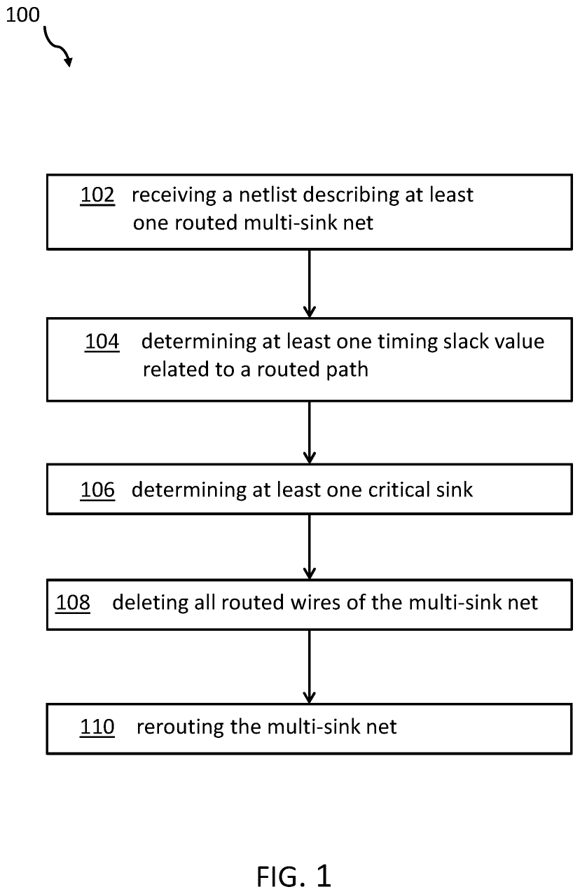

FIG. 1 shows a block diagram of an embodiment of the computer-implemented method 100 for improving a routing of a single chip multi-sink net of a semiconductor circuit. The method comprises receiving, 102, a netlist, in particular, design data. The netlist describes at least one routed multi-sink net—out of a large plurality of multi-sink nets of the netlist—and related timing information relating to a signal propagation delay value between a single source of the multi-sink net and one or more individual sinks of the multi-sink net.

The method 100 also comprises determining, 104, at least one timing slack—e.g., typically all from the one source of the selected net—value related to a routed path from the source to one of the individual sinks based on the timing information and determining, 106, at least one critical sink out of the individual sinks based on the related timing slack value. Thereby, the critical sink has a related timing slack value that is larger than a predefined threshold value, in particular <0.

Furthermore, the method comprises deleting, 108, all routed wires of the multi-sink net, wherein the routed wires relate to data describing physical shapes of connections between the source and the individual sinks. With this, space is created for finding a better path for the layout of the wires of the critical sub-net, i.e., the time critical connection from the source to the respective sink (i.e., where t_{slack}<0). The netlist information still describes which source shall be connected to which sink (logical netlist).

Last but not least, the method 100 comprises rerouting, 110, the multi-sink net, wherein at least one subnet of the multi-sink net, comprising the source and the critical sink, is routed before routing the remaining individual sinks of the multi-sink net. Hence, focus is given to the connection with the worst slack value.

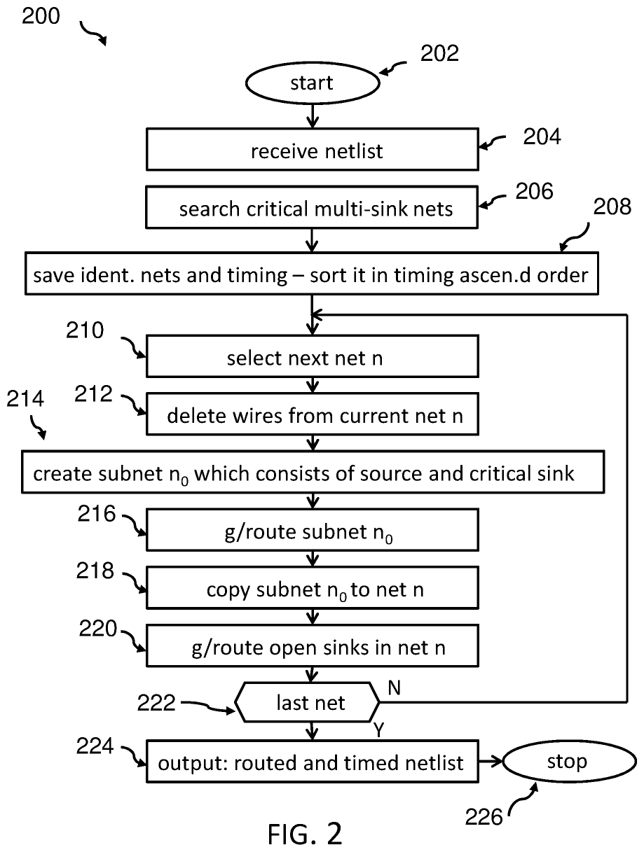

FIG. 2 shows a block diagram 200 of a more implementation-near embodiment of a proposed method 100. The processor starts at 202 with receiving, 204, the netlist. Next, 206, a search for multi-sink nets with a timing t_{slack}<t_{threshold} will be performed. It may again be noted that the time t_{slack} is negative in case of a critical sink. Thus, the absolute value of t_{slack} is larger than a given t_{threshold}.

As next step 208, the identified nets and the related timing are saved to the database. Within the database, the timing may be sorted in ascending or descending order, such that multi-sink nets, as well as connections with in a net from a source to the sinks can be identified in a severity order (or, in other words, a t_{slack} order).

Then, according to the order, a next net n is selected, 210. The wiring information of the selected current net n is eliminated, not referred to or deleted, 212. A new subnet n₀ will be created, 214. The created subnet n₀ consists of the source and the critical sink. Then, a routing or g/route process is applied to the selected subnet—step 216—and the result is copied, 218, to the net n (or more precisely the related part of the netlist). After that, the other open sinks in the net n are routed (g/route), 220.

It is then determined, 222, whether the last net is being routed. In case of “no” (“N”), the process returns back for selecting, 210, a next net to continue the cycle process. In case the last net has been routed—case “yes” “Y”—the results are copied to the original netlist including the new timing information. As final result, a completely routed and timed netlist becomes available, 224, and the process is stopped at 226.

In other words, the post process algorithm analyzes multi-sink nets in a fully routed and timed design to identify multi-sink nets, which do not reach the timing target (t_{slack}<t_{threshold}). To analyze the segments, different methods for a calculation of the RC delay may be used which may use the information about the metal layer, the length of the wire, the wire width, etc.

In the RC (resistor/capacitor) model, a normalized table may be used which lists the wire delays based on the length, the width and buffers. Such a list may be called the cycle reach table. For the net length calculation of the Manhattan-distance wire length calculation between a source and each sink may be applied; it may also be assumed that there is no scenic net length in that Manhattan-distance. A database can be used to store the identified nets with other timing and length information. The nets inside the database can be sorted, so that the most timing critical net is first (ascending order). Starting with the first net, the existing route is deleted. Then the proposed algorithm creates the subnet n₀ which is an electrical leak connected component containing the source and the critical sink of that net. Then the router is used to generate a route for the subnet n₀. After that, the critical subnet is copied back to the net n and all other open sinks in the net n are routed.

Instead of copying the subnet n₀ back to the net n, the algorithm may also build the subnet n₁, which is then a connected component containing the subnet n₀ and the next critical sink(s) of net n. Then the remaining open connections between the source and the other sinks inside the subnet n1 are also routed. After that the next net inside the database is picked and new g/routes and c/routes are created in the same way, as described above.

It may also be mentioned that instead of deleting those wires of critical multi-sink nets a cost model may be used for a priority calculation of critical sinks. This way, the most critical sink has the lowest cost and the less critical or uncritical sinks are assigned higher costs. Such a model may avoid the deletion and the add process for the wires.

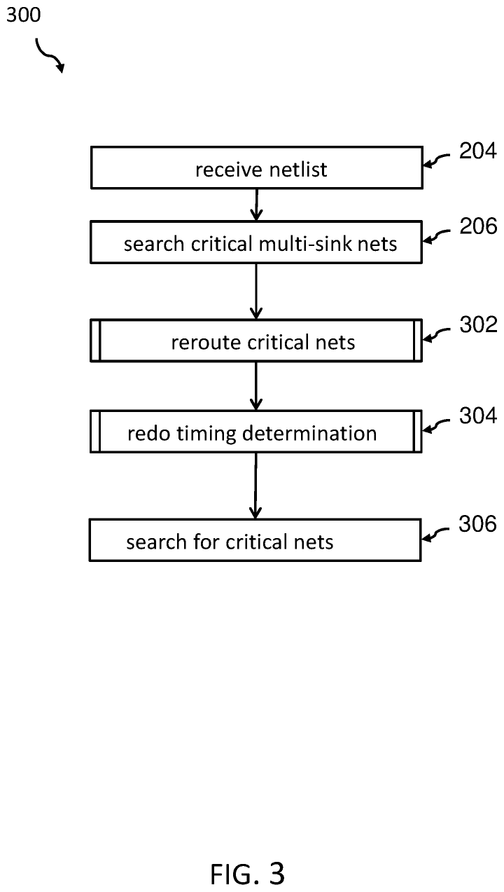

FIG. 3 shows a shortened block diagram of an advanced embodiment 300 of the proposed method. Again, as in FIG. 2, the first two steps are repeated for completeness reasons (receive the netlist, 204; search for critical multi-sink nets, 206). Then, in the sense of and according to the embodiment of FIG. 2, critical nets (one or more multi-sink nets with critical sinks) are rerouted, 302. Then, a timing parameter determination of the complete netlist may be performed, 304, again. The term “again” is used here because the originally received netlist has been “timed” (i.e., timing parameters have been determined) already. Thus, the here proposes concept performs a part of the routing again of some routes, especially for those that comprise the critical connections/nets with which the circuit would not be functional.

Such a new timing parameter determination may discover new critical multi-sink nets in the partially rerouted netlist, which may have to be addressed in a new iteration of the optimization process (search for critical nets, 306).

It may again be noted that before the rerouting of the wire information identified critical multi-sink nets may be deleted, in particular, data about the routed wires, not the source and sink information per se. The related benefit is to have more free space to re-implement paths which have been critical before.

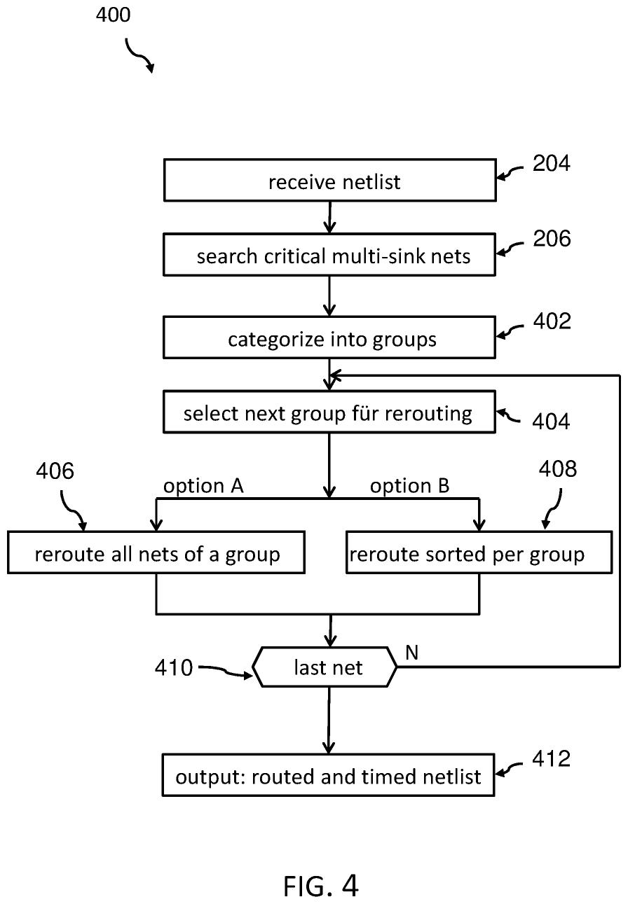

FIG. 4 shows another shortened block diagram of an advanced embodiment 400 of the proposed method. Also here, the first two steps (“receive netlist”/204 “; search critical multi-sink nets”/206) are comparable to the related steps of FIG. 2.

Then, a categorization of the critical multi-sink nets is performed, 402. The grouping or categorization may be performed according to predefined parameters, e.g., according to the most critical sink (the one with the most negative value) in each of the identified multi-sink nets, or a weighted average of the slack values showing criticality. Hence, identifies multi-sink nets are assigned to specific groups (e.g., critical, semi-critical, on-critical).

Then, a group for a rerouting process in the sense of FIG. 2 is selected, 404. Now two options are available: option A, and option B. According to option A, 406, all critical multi-sink nets of the group comprising the critical multi-sink nets—i.e., each of the nets having one or more critical sinks—are rerouted together or in a random order. Alternatively, according to option B, 408, a stepwise rerouting in each group will be performed sequentially. Thus, the process starts with the multiple-sink net having the worst slack value (the highest negative t_{slack} value). Step-by-step, the multi-sink-nets and within that, the net with the least bad critical connection is selected for a rerouting process.

Then it is determined, 410, whether the last net has been rerouted. If that is not the case—case “no” (“N”)—the process returns back to the selection of a next group for a rerouting, 404. Alternatively—case yes (“Y”)—as output, a routed (rerouted) and timed netlist for the IC becomes available, 412, for further processing.

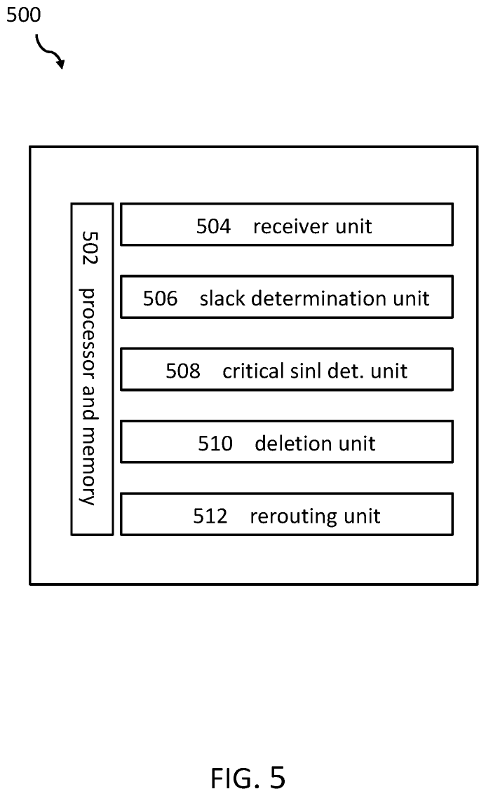

FIG. 5 shows a block diagram of the proposed routing system 500 for improving a routing of a single chip multi-sink net of a semiconductor circuit. The system 500 comprises a processor and a memory (together 502) coupled to the processor for executing program instructions. The system 500 comprises also a receiver unit 504 adapted to receiving a netlist, the netlist describing at least one routed multi-sink net and timing information related to a signal propagation delay value between a source of the multi-sink net and individual sinks of the multi-sink net.

Additionally, the system 500 comprises a slack determination unit 506 adapted for determining at least one timing slack value related to a routed path from the source to one of the individual sinks based on the timing information, and a critical sink determination unit 508 adapted for determining at least one critical sink out of the individual sinks based on the related timing slack value, wherein the critical sink has a related timing slack value that is larger than a predefined threshold value.

Moreover, the system comprises a deletion unit 510 adapted for deleting all routed wires of the multi-sink net, wherein the routed wires relate to data describing physical shapes of connections between the source and the individual sinks and, the system 500 comprises a rerouting unit 512 adapted for rerouting the multi-sink net, wherein at least one subnet of the multi-sink net, comprising the source and the critical sink, is routed before routing the remaining individual sinks of the multi-sink net.

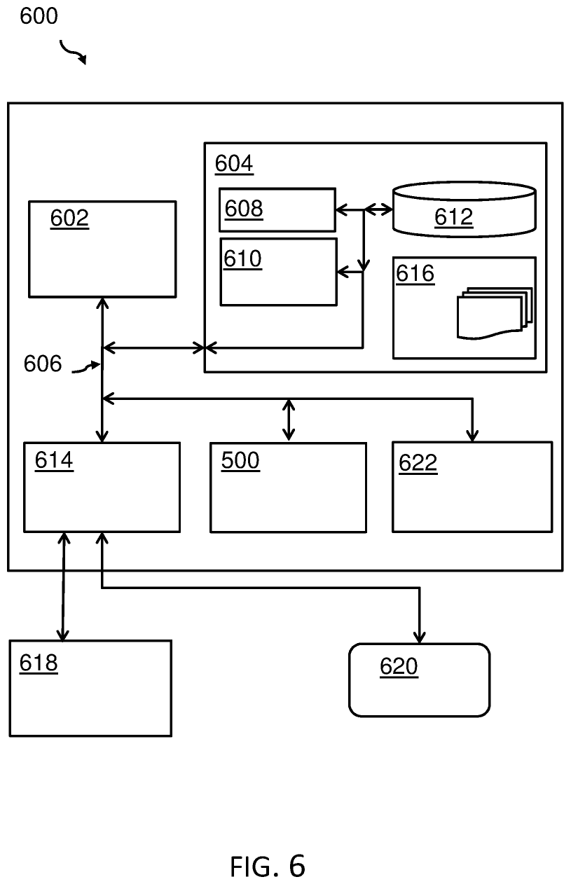

Embodiments of the invention may be implemented together with virtually any type of computer, regardless of the platform being suitable for storing and/or executing program code. FIG. 6 shows, as an example, a computing system 600 suitable for executing program code related to the proposed method.

The computing system 600 is only one example of a suitable computer system, and is not intended to suggest any limitation as to the scope of use or functionality of embodiments of the invention described herein, regardless, whether the computer system 600 is capable of being implemented and/or performing any of the functionality set forth hereinabove. In the computer system 600, there are components, which are operational with numerous other general purpose or special purpose computing system environments or configurations. Examples of well-known computing systems, environments, and/or configurations that may be suitable for use with computer system/server 600 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 600 may be described in the general context of computer system-executable instructions, such as program modules, being executed by a computer system 600. Generally, program modules may include routines, programs, objects, components, logic, data structures, and so on that perform particular tasks or implement particular abstract data types. Computer system/server 600 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 600 is shown in the form of a general-purpose computing device. The components of computer system/server 600 may include, but are not limited to, one or more processors or processing units 602, a system memory 604, and a bus 606 that couple various system components including system memory 604 to the processor 602. Bus 606 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 600 typically includes a variety of computer system readable media. Such media may be any available media that is accessible by computer system/server 600, and it includes both, volatile and non-volatile media, removable and non-removable media.

The system memory 604 may include computer system readable media in the form of volatile memory, such as random access memory (RAM) 608 and/or cache memory 610. Computer system/server 600 may further include other removable/non-removable, volatile/non-volatile computer system storage media. By way of example only, a storage system 612 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 606 by one or more data media interfaces. As will be further depicted and described below, memory 604 may include at least one program product having a set (e.g., at least one) of program modules that are configured to carry out the functions of embodiments of the invention.

The program/utility, having a set (at least one) of program modules 616, may be stored in memory 604 by way of example, and not limiting, as well as an operating system, one or more application programs, other program modules, and program data. Each of the operating systems, one or more application programs, other program modules, and program data or some combination thereof, may include an implementation of a networking environment. Program modules 616 generally carry out the functions and/or methodologies of embodiments of the invention, as described herein.

The computer system/server 600 may also communicate with one or more external devices 618 such as a keyboard, a pointing device, a display 620, etc.; one or more devices that enable a user to interact with computer system/server 600; and/or any devices (e.g., network card modem, etc.) that enable computer system/server 600 to communicate with one or more other computing devices. Such communication can occur via Input/Output (I/O) interfaces 614. Still yet, computer system/server 600 may communicate with one or more networks such as a local area network (LAN), a general wide area network (WAN), and/or a public network (e.g., the Internet) via network adapter 622. As depicted, network adapter 622 may communicate with the other components of computer system/server 600 via bus 606. It should be understood that, although not shown, other hardware and/or software components could be used in conjunction with computer system/server 600. Examples, include, but are not limited to: microcode, device drivers, redundant processing units, external disk drive arrays, RAID systems, tape drives, and data archival storage systems, etc.

Additionally, the routing system 500 for improving a routing of a single chip multi-sink net of a semiconductor circuit 500 may be attached to the bus system 606. It may be noted that the processor and memory with reference numeral 502 may be identical with the processor and memory shown in FIG. 6.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RAY), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for improving a routing of a single chip multi-sink net of a semiconductor circuit, the method comprising:
receiving a netlist, the netlist describing at least one routed multi-sink net and timing information related to a signal propagation delay value between a source of the multi-sink net and individual sinks of the multi-sink net;
determining at least one timing slack value related to a routed path from the source to one of the individual sinks based on the timing information;
determining at least one critical sink out of the individual sinks based on the related timing slack value, wherein the critical sink has a related timing slack value that is larger than a predefined threshold value;
deleting all routed wires of the multi-sink net, wherein the routed wires relate to data describing physical shapes of connections between the source and the individual sinks; and
rerouting the multi-sink net, wherein at least one subnet of the multi-sink net, comprising the source and the critical sink, is routed before routing remaining individual sinks of the multi-sink net.

2. The method according to claim 1, also comprising:
determining multiple critical multi-sink nets, wherein each of the critical multi-sink nets comprises at least one critical sink; and
selecting iteratively one of the determined multiple critical multi-sink nets for a routing iteration, wherein the routing iteration comprises a rerouting of the iteratively selected one of the determined multiple critical multi-sink nets.

3. The method according to claim 2, also comprising:
determining an order of the critical sinks of each of the determined multiple critical multi-sink nets, wherein a rank in the order is defined by a decreasing slack value of the respective critical sinks.

4. The method according to claim 3, also comprising:
rerouting the multiple multi-sink nets simultaneously, wherein subnets of the multiple multi-sink nets are routed one after another according to the determined decreasing order of their respective critical sinks.

5. The method according to claim 3, wherein the determining the order of the critical sinks comprises:
assigning the critical sinks to one slack group of a predefined set of slack groups.

6. The method according to claim 5, also comprising:
rerouting the multiple multi-sink nets slack group by slack group starting with the slack group comprising the sinks having worst slack values.

7. The method according to claim 1, also comprising:
after the rerouting of one or more the multi-sink nets comprising critical sinks, rerouting the semiconductor circuit with all remaining multi-sink nets of all devices of the complete single chip.

8. The method according to claim 1, also comprising:
determining all non-critical multi-sink nets and/or all non-critical point-to-point nets from the netlist, wherein a not critical multi-sink net and/or a non-critical point to point net is characterized by a positive slack value larger than a predefined threshold value; and
deleting all connections relating to the non-critical multi-sink nets and/or the non-critical point to point nets from the netlist.

9. The method according to claim 8, also comprising:
rerouting the multi-sink nets comprising a critical sink after the deleting all connections relating to the non-critical multi-sink; and
rerouting the remaining portions of the netlist excluding the multi-sink nets comprising a critical sink.

10. The method according to claim 9, also comprising:
determining timing parameters of the completely rerouted netlist.

11. A routing system for improving a routing of a single chip multi-sink net of a semiconductor circuit, the system comprising:
a processor and a memory coupled to the processor for executing program instructions;
a receiver unit adapted to receiving a netlist, the netlist describing at least one routed multi-sink net and timing information related to a signal propagation delay value between a source of the multi-sink net and individual sinks of the multi-sink net;
a slack determination unit adapted for determining at least one timing slack value related to a routed path from the source to one of the individual sinks based on the timing information;
a critical sink determination unit adapted for determining at least one critical sink out of the individual sinks based on the related timing slack value, wherein the critical sink has a related timing slack value that is larger than a predefined threshold value;
a deletion unit adapted for deleting all routed wires of the multi-sink net, wherein the routed wires relate to data describing physical shapes of connections between the source and the individual sinks; and
a rerouting unit adapted for rerouting the multi-sink net, wherein at least one subnet of the multi-sink net, comprising the source and the critical sink, is routed before routing remaining individual sinks of the multi-sink net.

12. The system according to claim 11, wherein the critical sink determination unit is also adapted for determining multiple critical multi-sink nets, wherein each of the critical multi-sink nets comprises at least one critical sink, and selecting iteratively one of the determined multiple critical multi-sink nets for a routing iteration, wherein the routing iteration comprises a rerouting of the iteratively selected one of the determined multiple critical multi-sink nets.

13. The system according to claim 12, wherein the critical sink determination unit is also adapted for determining an order of the critical sinks of each of the determined multiple critical multi-sink nets, wherein a rank in the order is defined by a decreasing slack value of the respective critical sinks.

14. The system according to claim 13, wherein the rerouting unit is also adapted for rerouting the multiple multi-sink nets simultaneously, wherein subnets of the multiple multi-sink nets are routed one after another according to the determined decreasing order of their respective critical sinks.

15. The system according to claim 13, wherein the determining the order of the critical sinks of the critical sink determination unit is also adapted for assigning the critical sinks to one slack group of a predefined set of slack groups.

16. The system according to claim 15, wherein the rerouting unit is also adapted for rerouting the multiple multi-sink nets slack group by slack group starting with the slack group comprising the sinks having worst slack values.

17. The system according to claim 11, wherein the rerouting unit is also adapted for, after the rerouting of one or more the multi-sink nets comprising critical sinks, rerouting the semiconductor circuit with all remaining multi-sink nets of all devices of the complete single chip.

18. The system according to claim 11, also comprising:
a non-critical multi-sink net unit adapted for determining all non-critical multi-sink nets from the netlist, wherein a not critical multi-sink net and/or a non-critical point to point net is characterized by a positive slack value larger than a predefined threshold value; and
deletion unit adapted for deleting all connections relating to the non-critical multi-sink nets and/or a non-critical point to point nets from the netlist.

19. The system according to claim 18, wherein the rerouting unit is also adapted for:
rerouting the multi-sink nets comprising a critical sink after the deleting all connections relating to the non-critical multi-sink;
rerouting the remaining portions of the netlist excluding the multi-sink nets comprising a critical sink; and
wherein the system comprises a timing parameter unit adapted for determining timing parameters of the completely routed netlist.

20. A computer program product for improving a routing of a single chip multi-sink net of a semiconductor circuit, the computer program product comprising a computer readable storage medium having program instructions embodied therewith, the program instructions being executable by one or more computing systems or controllers to cause the one or more computing systems to:
receive a netlist, the netlist describing at least one routed multi-sink net and timing information related to a signal propagation delay value between a source of the multi-sink net and individual sinks of the multi-sink net;
determine at least one timing slack value related to a routed path from the source to one of the individual sinks based on the timing information;
determine at least one critical sink out of the individual sinks based on the related timing slack value, wherein the critical sink has a related timing slack value that is larger than a predefined threshold value;
delete all routed wires of the multi-sink net, wherein the routed wires relate to data describing physical shapes of connections between the source and the individual sinks; and
reroute the multi-sink net, wherein at least one subnet of the multi-sink net, comprising the source and the critical sink, is routed before routing remaining individual sinks of the multi-sink net.
